(19) United States
(12) Patent Application Publication
(10) Pub. No.: US 2014/0316836 A1
(43) Pub. Date: Oct. 23, 2014

(54) METHODS AND SYSTEMS FOR GENERATING CUSTOMIZED GROUP PLANS

(71) Applicant: Randolph Bruce Lipscher, Albuquerque, NM (US)

(72) Inventor: Randolph Bruce Lipscher, Albuquerque, NM (US)

(21) Appl. No.: 14/217,191

(22) Filed: Mar. 17, 2014

Related U.S. Application Data
(63) Continuation-in-part of application No. 13/371,432, filed on Feb. 12, 2012, now Pat. No. 8,725,590.
(60) Provisional application No. 61/799,045, filed on Mar. 15, 2013.

(51) Int. Cl. G06Q 10/10

(52) U.S. Cl. CPC G06Q 10/1093
USPC 705/7.19

(57) ABSTRACT

Systems for generating customized group (social) plans based on corresponding creator plans, external data, user preferences, and matching logic are disclosed. Creator plans are available for selection by users. The system may propose creator plans to user(s) as well as potential plan participants based on specific user attributes or group associations.

Once creator plans are selected, and additional user(s) are identified by the user, or the system, the system matches user preferences utilizing matching logic. Filters may be applied to optimize match results. The computer-suggested plan is then transmitted to potential users who may accept, reject, or negotiate with other users to try to change the items, characteristics, or elements of the plan.

External data and other plans may be used in generating the customized group plan. A single customized group plan may integrate multiple creator plans and set multiple goals for the user.

### CROSS-REFERENCE TO RELATED APPLICATIONS

The present application is a non-provisional of and claims the benefit and priority under 35 U.S.C. 119(e) of U.S. Provisional Application No. 61/799,045 filed Mar. 15, 2013 entitled “SOCIAL NETWORKING STABLE ALLOCATION MATCHING”, the entire contents of which is incorporated herein by reference for all purposes. Additionally, this application is a continuation-in-part of prior U.S. application Ser. No. 13/371,432, filed on Feb. 12, 2012, titled “METHODS AND SYSTEMS FOR GENERATING CUSTOMIZED USER PLANS” the contents of which is hereby incorporated in its entirety by reference.

### BACKGROUND

Many people strive to stay organized and optimize their time. Additionally, many people make plans with others that involve coordinating events, times, etc., with each other. In a world of ever increasing demand for time efficiency, group plans have become very difficult to manage. While some entities have designed systems to help provide, manage, etc., group plans, challenges still exist.

### BRIEF DESCRIPTION OF DRAWINGS

Example embodiments are illustrated by way of example and not limitation in the figures of the accompanying drawings, in which like references indicate similar elements and in which:

FIG. 1 illustrates a schematic overview of various modules of the system for generating customized group plans based on the one or more creator plans, in accordance with certain embodiments.

FIG. 2 illustrates an example network segment for implementing various aspects of methods and systems for generating customized group plans based on the one or more creator plans, in accordance with certain embodiments.

FIG. 3 illustrates architecture of the computer system for generating customized group plans based on the one or more creator plans, in accordance with certain embodiments.

FIGS. 4A and 4B are process flowcharts corresponding to the computer-implemented methods for customized group plans based on the one or more creator plans, in accordance with certain embodiments.

FIG. 5 illustrates plan creation and selection-related processes employed by the system in generating customized group plans based on the one or more creator plans, in accordance with certain embodiments.

FIG. 6 illustrates various aspects associated with processing of data by the system for generating customized group plans based on the one or more creator plans, in accordance with certain embodiments.

FIG. 7 illustrates Structure of a plan; (composed of elements and links), as well as the characteristics and properties of elements and links

FIG. 8 illustrates a numerical scale to grade preferences for plan elements, characteristics, properties, or specific items

FIG. 9 is a diagrammatic representation of an example machine in the form of a computer system, within which a set of instructions for causing the machine to perform any one or more of the methodologies discussed herein is executed.

### DESCRIPTION

BRIEF SUMMARY Planning is a process for accomplishing specific goals. Goals and types of plans may vary depending on the planners and the people trying to accomplish the goals. Plans may vary from a simple recipe to a complex business scheme. A plan may be viewed as a blueprint for personal or organizational growth and a road map for such development. A plan helps in defining objectives both in quantitative and qualitative terms, accounting for available resources, and other factors.

Just as no two people or organizations are alike, their plans are also not alike. It is, therefore, important to prepare a plan that keeps in mind the necessities of the person or enterprise. A plan is an important aspect of a human life or business. Plans may be repeated many times or overlap with other plans and may affect or conflict with each other.

Some plans are carefully prepared, for example, after conducting extensive research and analysis. Others plans are improvised. While careful preparations may be valuable, such preparations may take a significant amount of time and other resources, which could be otherwise used for execution of the plans and achieving the set goals. Furthermore, many people involved in planning may not have sufficient knowledge and expertise to develop a correct plan. Even a seemingly simple goal of losing weight may be overcomplicated. On the other hand, offhand plans may be misguided and lead to incorrect results. Planning is further complicated when a person or organization tries to generate or execute multiple plans simultaneously, For example, multiple plans may compete for the same resources (e.g., person's time or finances).

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are computer-implemented methods and systems for generating user specific group plans based on corresponding creator plans and user data. The creator plans may be generated by experts in their respective fields, by businesses, and even by users. The creator plans may be available for selection and, in certain embodiments, for purchase by users. A system may suggest certain creator plans to a user, as well as certain participants for the group plan. Once the one or more creator plans are identified for a particular user, as well as the proposed participants the system may generate a customized group plan based on these creator plans and corresponding user data, such as user input, user state, and privacy settings, other selected group participants, other participant user data, such as user input, user state, and privacy settings. External data and other plans of this and other users may be also used during generation of the customized group plan. One customized group plan may integrate multiple creator plans and have multiple goals for the user. The customized group plan may be dynamically generated and updated based, for example, on changes to user(s) data, or through the process of negotiation with other users regarding certain elements of the plan.

In certain embodiments, a computer-implemented method may involve retrieving the one or more creator plans based on one or more of the following: a user selection of the one or more creator plans, another system user's selection of the one or more creator plans, selection by the system of the one or more creator plans, user data, and external input. The method may then match the users preferences with other users preferences by utilizing matching logic (such as, but not limited to Gale-Shapey stable matching algorithm, or other matching methods.). The method may then continue with generating the customized group plan based on integration of the one or more retrieved creator plans with the, matching output, user input, user state, and privacy settings. The generated customized group plan includes a set of instructions to be executed by the user. The method may proceed with presenting the customized computer suggested group plan to the user. The user(s) may then accept, reject, or begin a process of negotiating with other users to try to change the elements of the suggested plan. Once the plan is accepted by a predefined number of users—the plan is finalized.

The finalized customized group plan is then presented to all users. User follows the plan by completing each plan element: The system tracks plan usage by receiving one or more responses from the user(s) about completing one or more instructions from the set of instructions. User may also rate various elements of the plan, which may be used by the system integrator in future plan making.

In certain embodiments, failure by the one or more user(s) to respond to the presented customized group plan may be considered a response that may further be acted upon automatically by the system, or by the designated system user with appropriate clearance (e.g., a system operator).

In certain embodiments, the computer-implemented method also involves updating the customized group plan based on the one or more responses received from the user(s) and presenting the updated customized group plan to the user(s). Updating may be also performed based on changes to the user input, user state, and privacy settings associated with the user in addition to, or instead of, the responses received from the user. In certain embodiments, generating the customized group plan may involve adding external data to the combination of the data originally provided in the creator plan and user input, user state, and privacy setting associated with the user. Examples of the external data may include an advertisement, a product placement, weather data, a government health database of food nutrition, restaurant ratings, bar ratings, travel carrier ratings, travel carrier schedules, season of year, entertainer ratings or popularity, cost data, event times and dates, travel time between home and event, travel time between events, availability of entertainment media, traffic data, river and ocean water levels and tides, availability of babysitters, and a current mortgage interest rate. In the same or other embodiments, a plan is generated based on other user data in addition to the user input, user state, and privacy settings associated with the user. Examples of other user data may include a relationship of the user with another user or group, an association of one use with another, success in implementing one or more creator plans by one or more other users, and one or more related plans. For example, a user plan may be profiled after another plan previously used by a friend of the user. In another example, successful implementation of one plan may result in automated generation of another plan.

In certain embodiments, the computer-implemented method may also involve generating the one or more creator plans based on input from one or more plan creators. The input from the one or more plan creators may be provided using a plan creation tool, which may be an online web-based application.

In certain embodiments, the computer-implemented method may also involve collecting a fee from the user based on the user selection of the one or more creator plans. In the same or other embodiments, the computer-implemented method may involve providing a credit to the user based on user selection of one or more promotions, or plans. For example, a creator plan may give the plan chooser a free pass to a bar for sponsoring a plan that includes visiting the bar. Alternatively, the user may participate in certain promotions (e.g., signing up for a gym membership or purchasing a certain product) that may offset part of or the entire fee associated with the selected creator plan.

In certain embodiments, the computer-implemented method also involves presenting multiple creator plans to the user and receiving the user selection of one or more creator plans. Presentation of the multiple creator plans may involve presenting one or more evaluations corresponding to the multiple creator plans. Examples of the evaluations may be various forms of ranking of the plan itself or of the creator of the plan. Other examples include feedback by users, metrics associated with the popularity and success of the creator plans, and other forms of evaluations.

In certain embodiments, the computer-implemented method also involves suggesting the one or more creator plans to the user based on the user data or external input. For example, user data may indicate certain health conditions of the user, his or her financial state, time availability, social network, and other information that may be used to suggest creator plans. In the same or other embodiments, generating the customized group plan involves integration of the multiple creator plans with the user input, user state, and privacy settings associated with the user(s). As such, the multiple creator plans may lead to a single customized group plan, which may still have multiple goals. This integration may help to avoid user confusion when attempting to follow multiple customized group plans simultaneously. Furthermore, various synergistic effects may be found during integration of the multiple creator plans.

In certain embodiments, the computer-implemented method also involves collecting the user input, user state, and privacy settings associated with the user(s). This operation may be performed using a set-up wizard. Furthermore, this information may be periodically updated or automatically collected by the system and, in certain embodiments, used to dynamically update the existing customized group plans or to suggest new plans. In certain embodiments, the computer-implemented method also involves collecting additional information corresponding to user input, user state, or privacy settings associated with the user(s) based on the selection of the one or more creator plans by the user. For example, generating the customized group plan based on the selected creator plan may require additional data that was not previously available (e.g., current weight for a horseback riding trip).

In further examples, the above steps of the method proposed herein are stored on a machine-readable medium including instructions, which, when implemented by one or more processors, perform the steps. In yet further examples, subsystems or devices can be adapted to perform the recited steps. Other features, examples, and embodiments are described below.

### DETAILED DESCRIPTION

Example systems and methods for generating customized group plans are described. In the following description, for purposes of explanation, numerous specific details are set forth in order to provide a thorough understanding of the example embodiments. It will be evident, however, to one skilled in the art, that the present technology may be practiced without these specific details.

In this document, the terms “a” or “an” are used, as is common in patent documents, to include one or more than one. In this document, the term “or” is used to refer to a nonexclusive “or,” such that “A or B” includes “A but not B,” “B but not A,” “A and B,” and “A and/or B,” unless otherwise indicated.

Many aspects of socialization involve planning. For example, a father might wish to take his family wife and two 12 year old children on a river rafting trip . . . The father may then develop a set of steps, such as choosing a location, researching rafting companies, determining water and weather conditions, finding a nearby hotel and restaurant, and purchasing clothing. The related planning may be a time consuming and laborious process involving internet research, phone calls, and guess work. To simplify the process, many people often make assumptions and ignore certain factors. This, in turn, may cause the plan to fail, or to be unreliable or unrealistic.

The proposed methods and systems involve a process of dynamic generation of a customized group plan based on a collection of creator plans and based at least on user specific data Other data, such as the external data and plans from other users, may be used for generating a customized group plan as well. In certain embodiments, a user may be a representative of a group of users who acts on behalf of the group and makes a selection of the creator plan for all members of the group, for example, a father may make a selection of the creator plan for his family. The system may include one or more websites or applications for desktops, tablets, smartphones, and other types of computer systems and client devices. These websites or applications are accessed by the plan creators to create their creator plans, while users access the websites or applications to provide various inputs, states, privacy settings, and other information, as well as to retrieve the customized group plans generated by the system. The customized group plans are built based on the creator plans but are generally different from the creator plans. For example, the system may generate two different customized group plans based on the same creator plan. As different user inputs, states, and other information were used to generate these two customized group plans, the resulting customized group plans may be quite different from each other. In the above river rafting example, the customized group rafting vacation plan for one group may be focused more on clear water (for young children), while the customized group plan for another group may be focused more on class 5 rapids. Both customized group plans may be generated based on the same creator plan. While the creator plan may serve as a basis for the customized group plan, it is tailored to take into account the various factors (preferences and attributes) of a specific group. The customized group plans are dynamically generated for each specific group based on such data and may represent a comprehensive version of multiple plans. For example, a group of friends may be involved in the same exercise plan in order to emotionally support one another and save on fitness instructions and equipment costs.

The creator plans may include a range of customizable plans that can direct and assist users in planning group events. The creator plans may be submitted into the system by various professionals in corresponding fields, business people, and by other system users. For example, a river rafting company may provide group rafting plans directed at rafting novices and others. A restaurant owner may submit a plan for an anniversary dinner. In certain embodiments, these plans may be integrated with each other by the plan creator, by the user, or by the core integrator. Plan creators may help users in complicated environments. Users are not expected to recognize and analyze all aspects in each event or situation they encounter, and they generally do not have the resources to do so. Reviews or verifications of the expertise or credentials of the plan creators may be made available to users. Furthermore, users may contribute to the reviews of the experts or of their plans. In certain embodiments, the system may rank the creator plans based on their popularity, and other criteria. The systems and methods may also provide a plan creation tool, which may be a web-based tool, used by the plan creators to design and build the various creator plans encompassing various aspects of their particular expertise. The plan creators may post ongoing updates to their creator plans, which may be made available automatically to users of those creator plans or, more specifically, to update the customized group plans that are based on the modified creator plans.

The customized group plan is a set of instructions, which, through the functionality of the system, may guide a group of users in accomplishing a specific task or assist the group in reaching a desired specific or general goal. The internal structure of the customized group plan may be of many forms. For example, instructions of the customized group plan may be organized chronologically. In the same or other embodiments, instructions may be grouped into a series of steps or sub-goals. The customized group plan may be generated dynamically, which means that the instructions provided in the plan may not only be specific to the user's initial input but they may also change and adapt based on changes to the user's profile, preferences, associations, actions, feedback, and external data from this and other plans the user is following. For example, a river rafting plan may change because one users inability to make the date, or because of weather (e.g., sunny, rainy), and other variables.

The creator plans may be made available to users through the plan store, which may be part of the user interface. The plan store may allow users to browse and search various types of creator plans pertinent to their desired goals. The plan store may also guide users in selecting the creator plans that would be of interest to them or that may be beneficial to their overall or specific goals. In certain embodiments, the plan store may present semi-customized or fully-customized versions of the creator plans to users. In certain embodiments, a fully-customized version of the creator plan may be considered as the customized group plan. Thus, the plan store may offer the customized group plans in addition to, or instead of, the creator plans.

In certain embodiments, the newly created creator plans may be stored within a plan library. To select plans that meet some predefined criteria and can be used for a specific plan user or user group, the creator plans within the plan library may be filtered by a plan filterer using a plan filtering tool. The plan filtering tool or the plan filterer may be a plan user him- or herself, another system user (for example, a designated system user with appropriate clearance (herein also referred to as a system operator)), or a software application that will perform the filtering based on the predefined criteria. After the creator plans that meet the specified predefined criteria are located, they may be placed into a filtered plan library/plan store, thus becoming available for selection by a plan chooser.

In certain embodiments, the filtered creator plans that are found in the filtered plan library/plan store may be chosen by the plan chooser using a plan selection tool. The plan chooser may be the plan user him- or herself, another system user (for example, the designated system user with appropriate clearance (system monitor)), or a software application that will perform the selection process based on the predefined criteria.

In certain embodiments, the one or more chosen creator plans that have been retrieved from the filtered plan library/plan store may be modified by a plan modifier using a plan modification tool. The plan modifier may be the plan user him- or herself, another system user, for example, the designated system user with appropriate clearance (e.g., a system operator). It will be understood that the plan modifier is not limited to a human and may, in some embodiments, include a computer system, a computer script, or an automated device.

In certain embodiments, the plan creator, plan filterer, plan chooser, and plan modifier may be one and same or disparate persons, one and the same or disparate software applications, or a combination thereof. For example, the plan creator may be a system user other than the plan user that the creator plan is intended for, while the plan filterer may be a specifically designed software application that may or may not also be able to play the role of the plan chooser.

In certain embodiments, the creator plan may be modified by the plan modifier to include the executed customized group plans, or parts thereof, of this or other plan user or users. In certain embodiments, the customized creator user plan may be modified based on the one or more actions that have been taken by the plan user in response to one or more system messages. In certain embodiments, the plan user(s) may be notified by the system that a certain planned action has not been performed by him or her. This may be done using a timer. The plan user may then be requested to perform the missed planned action and to provide a corresponding input, based on which the customized group plan may be considered as executed.

In certain embodiments, the customized group plans may be rendered available for monitoring by other system users. In certain embodiments, the customized group plans may be adjusted or modified by the designated system users with relevant clearance (system monitor). For example, if a boy scout has checked in for a group hike, the system monitor may modify the customized group plan to cancel the hike.

In certain embodiments, monitoring of the fulfillment of the one or more customized group plans, as well as these plans' cancellations, may be performed using a plan monitoring module. In certain embodiments, the system may notify the one or more system monitors about the failure on the part of a user to perform an action the customized group plan of the plan user comprises. In certain embodiments, the system monitor may instruct the system to generate a message and send it to another system user or external recipient (for example, by email), thereby informing the recipient of the message about, or requesting him or her to take some action with regards to, the situation at hand. For the above purpose, a set of predefined, customizable system messages may be used.

In certain embodiments, the system may comprise an internal social network. The information that the plan user(s) submits into the internal social network may be used by the plan integrator/processor/expert system in creating new customized group plans, as well as for modifying the current and executed customized group plans.

In certain embodiments, the creator plan may be chosen for the plan user(s) by another user of the system. For example, a teacher may choose the suitable creator plan for a class project, sharing it with the class through the system. The multiple creator plans may be chosen for the plan user by another user or the software application just as well, with the goal of narrowing down the scope of user selection while taking the plan user's preferences or special needs into account. The plan user may then choose from the given selection of the creator plans. This may be especially useful when the multiple creator plans to choose from are allocated to a specific user group.

In certain embodiments, the one or more creator plans chosen for the plan user by another user of the system may be accompanied by the latter's comments, for example, in the form of recommendations or instructions on how the customized group plan to be generated based on the chosen creator plan. In certain embodiments, the current customized group plans may be rendered reviewable to the designated system user with relevant clearance (system monitor) and commented on by the latter. The system may notify the plan user about his or her plan having been commented on, including a notification by email. In certain embodiments, the creator plans may be automatically filtered by a software application based on some predefined criteria.

In certain embodiments, the current customized group plan may be cancelled by the designated system user with relevant clearance (system monitor). In certain embodiments, the creator plan or plans, chosen by the plan user for him- or herself, or chosen by another system user or a software application for this plan user, may be cancelled by the designated system user with relevant clearance (system monitor). In certain embodiments, the system may be able to notify the plan user(s) for whom the cancelled creator plan was intended, and, in the same or other embodiments, may notify the plan user who chose this creator plan about the plan having been cancelled. The designated system user with relevant clearance (system monitor) who has cancelled the creator plan may be able to indicate the reason for the cancellation using a set of predefined, customizable messages.

In certain embodiments, the system may notify the designated system user with relevant clearance (system monitor) when the multiple creator plans are allocated to a group of system users to choose from. In this or other embodiments, the designated system user with relevant clearance (system monitor) may cancel the above selection, thereby notifying the plan user by whom the decision about the cancellation was made. The designated system user with relevant clearance (system monitor) may be able to add his or her comments to the cancellation notification, sent to the system user by whom the selection was made. Such cancellation notifications may be sent via the system or by email.

In certain embodiments, the plan user may be able to share the one or more chosen or allocated creator plans, or the one or more executed customized group plans, with other users of the system or specific user groups, accompanying the creator plans with his or her comments. The designated system user with relevant clearance (system monitor) may be able to receive notifications about the one or more creator plans or executed customized group plans being shared, and approve or disapprove of the sharing procedure, therein stating the reason for his or her decision. In this or other embodiments, the one or more creator plans, or the one or more executed customized group plans may be shared using the internal social network of the system.

In certain embodiments, the system may enable the plan user to identify other system users with similar current or executed customized group plans. In particular, this may be useful for enabling comment exchange and sharing of related advice in the system's internal social network. In certain embodiments, this function may be supervised/regulated by the designated system user with relevant clearance (system monitor). In certain embodiments, the customized group plan may contain links to, or be otherwise associated with, media of different types (for example, it may contain links to a video hosted by a public file sharing system). In certain embodiments, the customized group plan may contain links to web resources that provide relevant content. In certain embodiments, multiple types of system monitors with varying authority may be supported.

In certain embodiments the plan user may invite other specific users, or members of specific groups to partake in the plan. In other embodiments the system may invite users, or groups of users to participate in the plan. In other embodiments the system may suggest to the initial user other users, or groups of users to participate in the plan.

In certain embodiments the creator plan may consist of discrete elements that are linked together in a sequence. The discrete elements of the sequence may represent but is not limited to physical places, for example, a user's home, restaurants, bars, coffee houses, outdoor areas. The elements can also represent but is not limited to physical items, such as clothing, and sports items. The elements may also represent but is not limited to non-physical items such as events, for example, movies, concerts, book readings, sporting events, festivals, club meetings, church events

In certain embodiments the creator plan may consist of links between elements. Links may represent but is not limited to, time to travel between elements, walking distance, driving distance, flying distance

In certain embodiments each discrete elements of the creator plan may have specific characteristics and properties. For example if a discrete element is a movie. The movie may have the several characteristics including title, genre, year made, director, lead actor, supporting actor, original screenplay. Each characteristic may appeal differently to different plan users. As such each characteristic may have a different preference level per user. These different preference levels may be represented numerically as a number on a numerical scale. These preferences may be gathered from users and used as a basis for determining common interests for a group of users. Moreover these preference levels may be used by matching logic to create a plan that is of high interest to users.

In certain embodiments, the system may employ matching logic for example the Gale Shipley logic where a stable matching between two sets of elements given a set of preferences for each element can be calculated.

In certain embodiments, the system may employ the following matching logic: The “assignment problem” logic which seeks to find a matching in a weighted bipartite graph that has maximum weight.

In certain embodiments, the system may employ the following matching logic: The “stable roommate's problem” logic is similar to the Gale-Shipley logic, but differs in that all participants belong to a single pool (instead of being divided into equal numbers of “men” and “women”).

In certain embodiments, the system may employ the following matching logic: The “hospitals/residents problem” logic—similar to the Gale-Shipley logic however, differs in that the “women” can accept “proposals” from more than one “man” (e.g., a hospital can take multiple residents, or a college can take an incoming class of more than one student). Algorithms to solve the hospitals/residents problem can be hospital-oriented (female-optimal) or resident-oriented (male-optimal).

In certain embodiments, the system may employ the following matching logic: The “hospitals/residents problem with couples” logic allows the set of residents to include couples who must be assigned together, either to the same hospital or to a specific pair of hospitals chosen by the couple. The addition of couples to the hospitals/residents problem renders the problem NP-complete.⁽⁵⁾

In certain embodiments, the system may employ the following matching logic: The “matching with contracts problem” logic is a generalization of matching problem, in which participants can be matched with different terms of contracts.

In certain embodiments, the system may employ the following matching logic: The “matching with flexible wages” logic

In certain embodiments, the system may employ the following matching logic: Other types of matching logic—that allows for adjustable weighting of preferences

In certain embodiments, the system may employ the following matching logic. Other types of matching logic

In certain embodiments the system matching logic may determine the characteristics of each element in the Computer generated group plan. For example the Computer generated group plan may contain a Comedy movie, rather than an Adventure film.

In certain embodiments the system may determine the importance of a particular preference for a user. The system can then use this preference/importance ratio to create appropriate plans. For example if a user rates Western movies very highly in his preferences (1 on a scale from 1 to 5), but watching movies is less important (3 on a scale from 1 to 5)—preference/importance ratio would be 1/3, as opposed to another user who might have a ratio of 1/1. In certain embodiments the system these ratios may be used by the matching logic to determine the characteristics of the suggested elements in the Computer proposed plan. For example the Computer proposed plan contain a Western movie, rather than a Horror film.

In certain embodiments of the system the links may rate for preference, hi a similar manner to elements of the system. The preferences are then matched by matching logic. For example, it might be the preference of two plan users that plan events be linked via walking. The system would then seek to find events that would be within walking distance of each other. In other embodiments the link can be filtered to specify events within 0.5 miles. The links may also specify distance from an event to a user's home.

In certain embodiments of the system the Computer suggested plans are sent to users via e-mail, text message, via internet, telephonically, or other means for review.

In certain embodiments of the system the Computer suggested plan is reviewed and accepted by all users. The plan then becomes the Final Group plan. The system will then monitor users for compliance with the plan.

In certain embodiments of the system the Computer suggested plan is rejected by a proposed user. The user is then deleted from the list of participants in the plan. An e-mail message may be sent to the group users as a whole, or specific group members.

In certain embodiments of the system the Computer suggested plan is not accepted, or rejected by the user. Instead the user decides to begin the process of negotiation with other potential plan users. In this process the user may do the following:

1. Request a different plan. For example if the plan Is a dinner and movie plan, the user may request that the plan change to a swim and run plan.

2. Request a change to one or more elements of the plan. For example, if the plan is a dinner and movie plan, the user may request that movie be replaced with bowling

3. Request a change to one or more of the selected characteristics of one or more elements of the plan. For example if the plan is a Dinner at Greek restaurant and movie plan. The user may request that the plan change to a Dinner at French restaurant and movie.

4. Request a change in a specific item in the plan. For example if the plan was Dinner at Aldo's Italian restaurant, the user may request the system suggest another Italian restaurant

5. Request a change to one or more of the links in the plan. For example if the plan was dinner followed by a 20 minute car ride to a movie, the user may request the link we within walking distance.

In certain embodiment when the system receives a user's proposed changes, it may

1. Contact other potential group users immediately to determine if the proposed changes are acceptable. For example the proposed changes may be a change in dinner from 6 pm to 7 pm. These changes may be acceptable to other plan participants.

2. Send the user other, less optimal, results from the matching program to determine these results are acceptable to the user

3. Run a new matching program, and then contact the user to determine if changes are satisfactory. If the changes are satisfactory the system can send messages to other users with the new plan proposal.

If the proposed changes are accepted by the users the system sends the users a Finished Group plan. In certain embodiments the acceptance rate may be set at a percentage of accepting users. For example a mountain hike plan may move out of negotiation status, and to an Accepted Finished plan when more than 5 participants agree to the plan. Another example, a group rally plan may move out of negotiation status, and into Accepted Finished status when more than 30 percent of invitees have agreed to the plan. In another embodiment the plan may move to out of negotiation status and to Accepted Finished status when a particular user, or users agrees to participate in the plan.

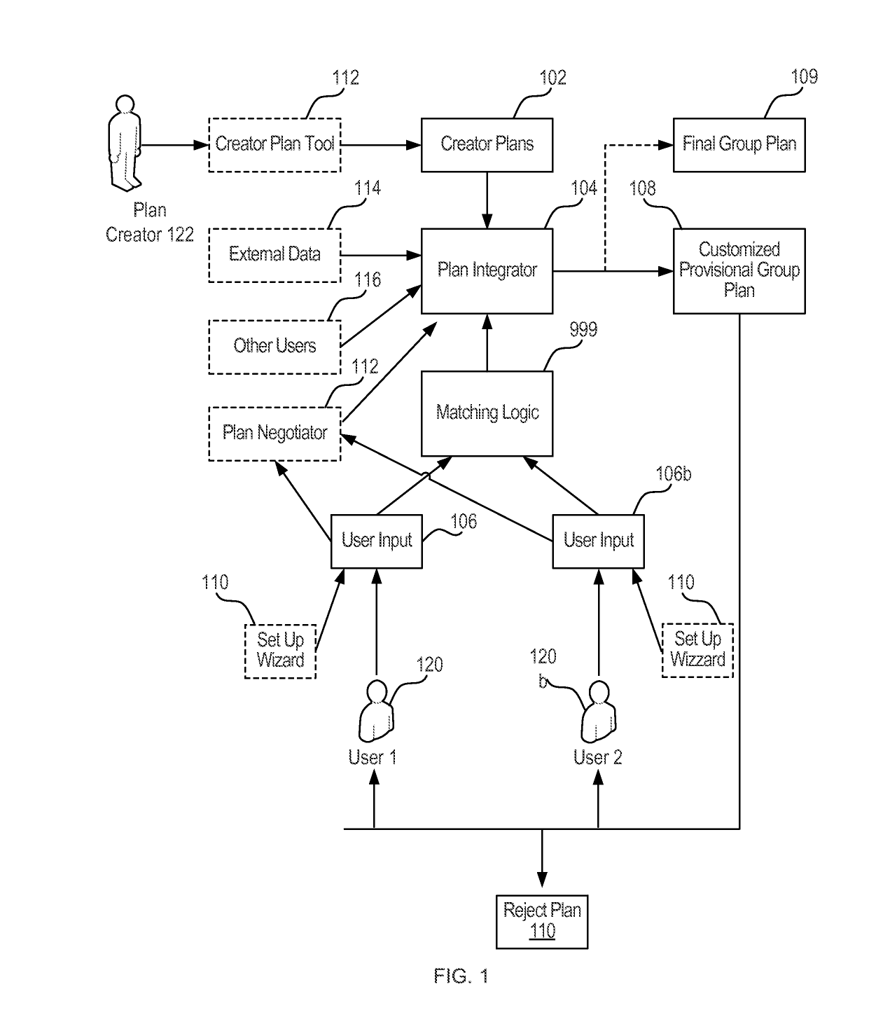

FIG. 1 is a schematic representation of the system 100 for generating the customized group plans 108 based on the corresponding creator plans 102 and additional data, in accordance with certain embodiments. Two types of participants in system 100 may include plan users 120 and 120b and plan creators 122. The plan users 120 and 120b may utilize the customized group plans 108 generated by system 100, while the plan creators 122 may generate or, more generally, provide the creator plans 102 to the system 100. In certain embodiments, the same person may be both the plan user 120 and the plan creator 122.

The creator plans 102 may typically be different from the customized group plans 108 and may be used by the plan integrator/processor/expert system 104 to generate the customized group plans 108. Additional data, such as user input, state, privacy settings (collectively represented by a block 106 AND 106b), the external data 114, and plans by other users or user groups (collectively represented by block, 116), matching logic 999, plan negotiator data 112 may be used by the plan integrator/processor/expert system 104 to generate the customized group plans 108. Each of these components and corresponding examples will now be described in more detail.

The plan creators 122 may utilize a plan creation tool 112 to develop the creator plans 102. Specifically, the plan creators 122 may submit various instructions, criteria, goals, and other data through the user interface of the plan creation tool 112. The plan creation tool 112 may include a graphical user interface. The plan creation tool 112 may contain a plan integrator/processor of its own to assist the plan creators 122 with generating the creator plans. In other embodiments, the plan creation tool 112 or the plan integrator/processor/expert system 104 may be used by the plan creators 122 for this purpose. The plan integrator/processor/expert system 104 may be used to simulate creation of the customized group plans 108 based on the creator plans 102 as the creator plans 102 are developed or generated. In certain embodiments, the plan creation tool 112 may automatically generate new creator plans 102 based on previously generated creator plans 102, or based on various inputs from the plan users 120.

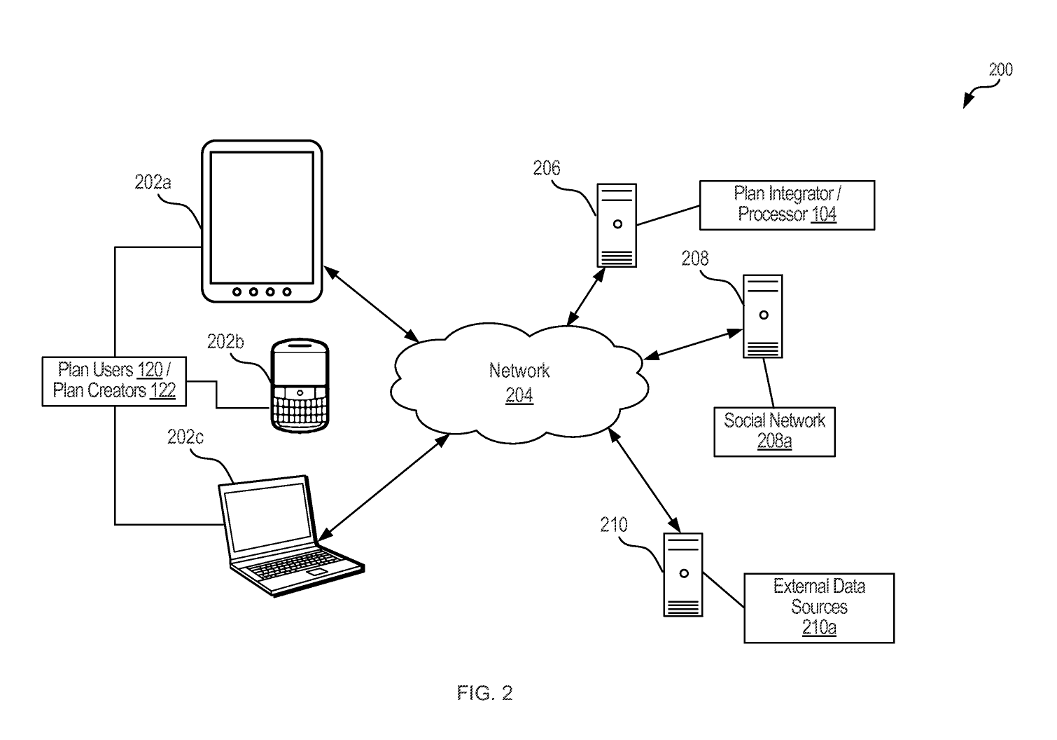

The creator plans 102 may be algorithms that are used by the plan integrator/processor/expert system 104 to generate the customized group plans 108. In certain embodiments, the creator plans 102 include data provided by the plan creators 122, by the plan creation tool 112, or by other sources. The creator plans 102 may be generated by the plan creation tool 112, by the system 100, or by using some other facilities. The creator plans 102 may be stored in an electronic form (for example, in a database associated with the system 100 and further described below with reference to FIG. 2).

The creator plans 102 may include instructions that are chronologically sequential or non-sequential. In certain embodiments, the order of instructions in the creator plan is different from the order of instructions in the corresponding customized group plan generated based on the aforementioned creator plan. In the same or other embodiments, not all instructions from the creator plan may be used in the corresponding customized group plan. Some of the instructions appearing in the one or more creator plans may be rearranged or removed during user generation based on user-specific and other data. The instructions or steps in the customized group plans 108 or creator plans 102 may be grouped into sub-sets with specific sub-goals corresponding to one or more of these sub-sets.

Some specific examples of creator plans 102 may be a lunch and garden walk plan created by a Wildflower association., a group exercise plan created by an aerobics or yoga instructor, and a group investing plan created by an investment club. Other types of creator plans 102 may be used as well. Some creator plans 102 may be created by the system based on various inputs to the system. For example, the system 100 may utilize the existing creator plans 102 to generate the new creator plans 102. User feedback may be relied on to modify the existing creator plans 102, or generate new creator plans 102. In certain embodiments, the system 100 may be coupled with a web crawler to search for additional information or instructions for existing plans and even for fulfilled plans.

Some creator plans 102 may be offered to the plan users 120 for a fee. Other plans may be offered free of charge. In certain embodiments, the fee for the plan is determined based on the various feedback received from the plan users 120, 120b, such as the plan users' success in using one or more of the plans, the users' satisfaction with their user experience, and other factors.

The creator plans 102 may have one or more characteristics associated with the plans and may be used, in certain embodiments, for presenting these creator plans to the plan users 120, 120b. For example, the plan users 120, 120b may be made aware of the identity of the plan creators 122 or, more specifically, they may be informed about their reputation, credentials, feedback, and other relevant information.

In order to generate a customized group plan 108, the integrator/processor/expert system 104 may use the one or more creator plans 102 selected by the user, the system 100, or otherwise submitted to the integrator/processor/expert system 104, as well as data from matching logic 999, and the plan negotiator 112. The user input, user state, and user privacy settings, which are collectively shown as block 106, 106b in FIG. 1. The user input is defined as data created by the one or more users or user groups during the course of their interactions with the system. Examples include specific user feedback, (e.g., a user indicating that he or she is rated a coffee bar 5 stars after following a specific group desert plan), given in response to prompts by the integrator/processor/expert system 104, and submitted by the user to the integrator/processor/expert system 104, or to other recipients, and indirect responses (e.g., someone in the social network indicates a preference that indirectly affects the user). The user state is defined as a set of user-associated data stored in the system, which may be generated by the user and submitted directly to the system. The user-associated data may also be submitted to the system indirectly, or generated by other users. The user state generally reflects the user's past, current, and predicted future state. The prediction of future user states may be performed by the integrator/processor/expert system 104, or by using other facilities. An example of a past user state may be an indication that the user has felt depressed previously after watching a war movie. An example of a current user state may be the fact that the user loves white water rafting. An example of a predicted future state may be the fact that integrator/processor/expert system 104 has predicted that the user will want to celebrate with his friends because his or her birthday is this upcoming weekend. This information/prediction may be submitted by other users.

Data corresponding to the user state may also include various biometric data. Examples of biometric data include fingerprints, face recognition, Deoxyribonucleic Acid (DNA), palm prints, hand geometry, iris recognition, and scent. Biometric data may also include various characteristics related to the behavior of a person, such as typing rhythm, gait, and voice. The system 100 may interface with various hardware monitoring devices, such as Global Positioning System (GPS) units, heart-rate monitors, accelerometers used for exercise, wireless weight/health monitors, and others. Data provided by these devices may be received and processed by the integrator/processor/expert system 104 when the customized group plan is being devised.

The user input, user state, and user privacy settings may be collected using a setup wizard 110. The setup wizard 110 may provide a set of questions to which the user will respond. These questions may be dynamically generated by the integrator/processor/expert system 104 to facilitate the collection of user data and, in certain embodiments, the creation of a user profile and user preferences in the system 100. The setup wizard 110 may also function to assist the user in selecting the creator plans 102. The initial input provided by a user (e.g., using the setup wizard 110) may be supplemented by other inputs from the user and other sources. These other sources may provide external data 114 and the plans of other users or user groups 116.

External data 114 is defined as data generated outside the system 100. Some examples of external data 114 include commercial advertisements, product placements, current weather data, a government health database of food nutrition, and current mortgage interest rates. The system 100 may include specifically designed web crawlers that retrieve the needed external data from other sources. The web crawlers may be automatically generated based on various parameters provided in the creator plans 102. The external data 114 may be used to dynamically adjust the customized group plans. For example, if the system 100 determines that a geographical area of a particular user has bad or good weather, it may dynamically adjust the potential recreational activities based on this information.

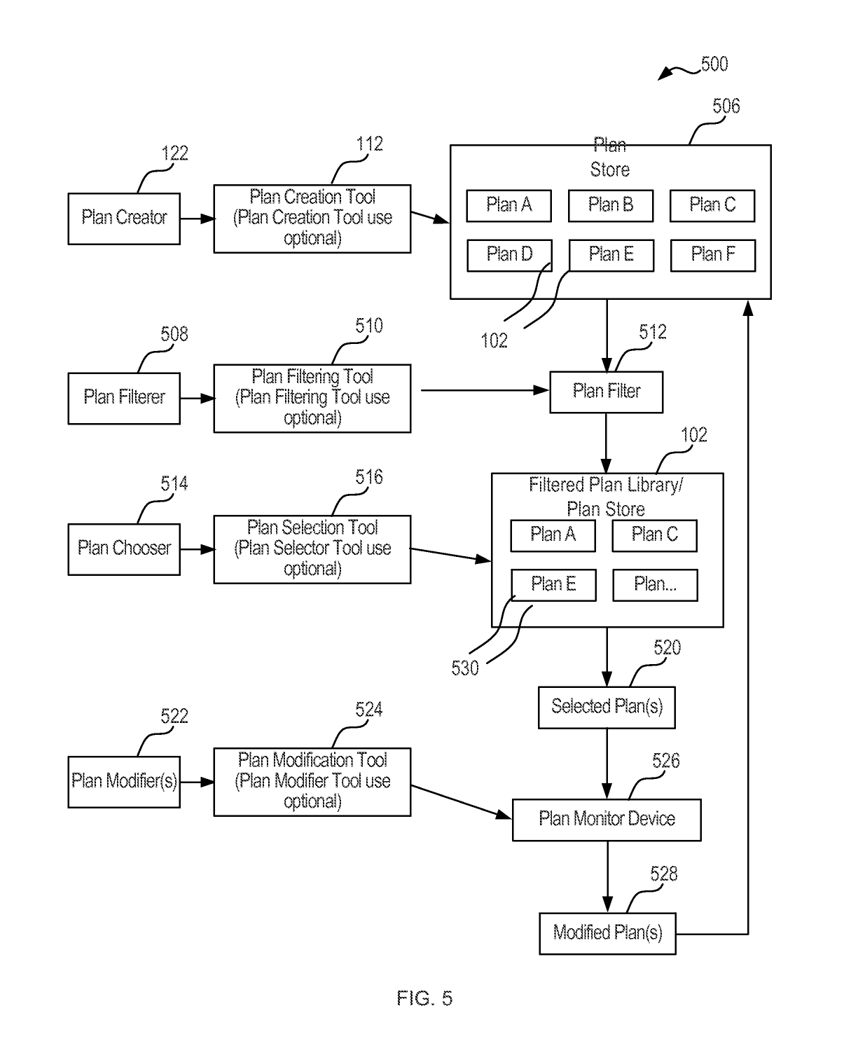

Plans (FIG. 5) are composed of plan elements (1000), and links between plan elements 1001. The elements and links can be arranged in a sequential, or non-sequential order. An example of elements would be a Restaurant, and a Coffee Bar. An example of a link would be the distance between the elements.

Elements and Links (FIG. 5) may consist of characteristics and properties. For example Element N (1002) is a restaurant which may have the following characteristics. Characteristic A: Type of Food served: Greek, Latin, Kosher, Seafood. Characteristic B Formality of dining: Formal, Casual, Beachwear. The restaurant may have properties such as capacity: (less than 100 seats, greater than 100 seats). A link may have characteristics as well (1003). For example a links characteristic may include walking, driving by personal vehicle, transportation via subway, taxi, airline, bus or train.

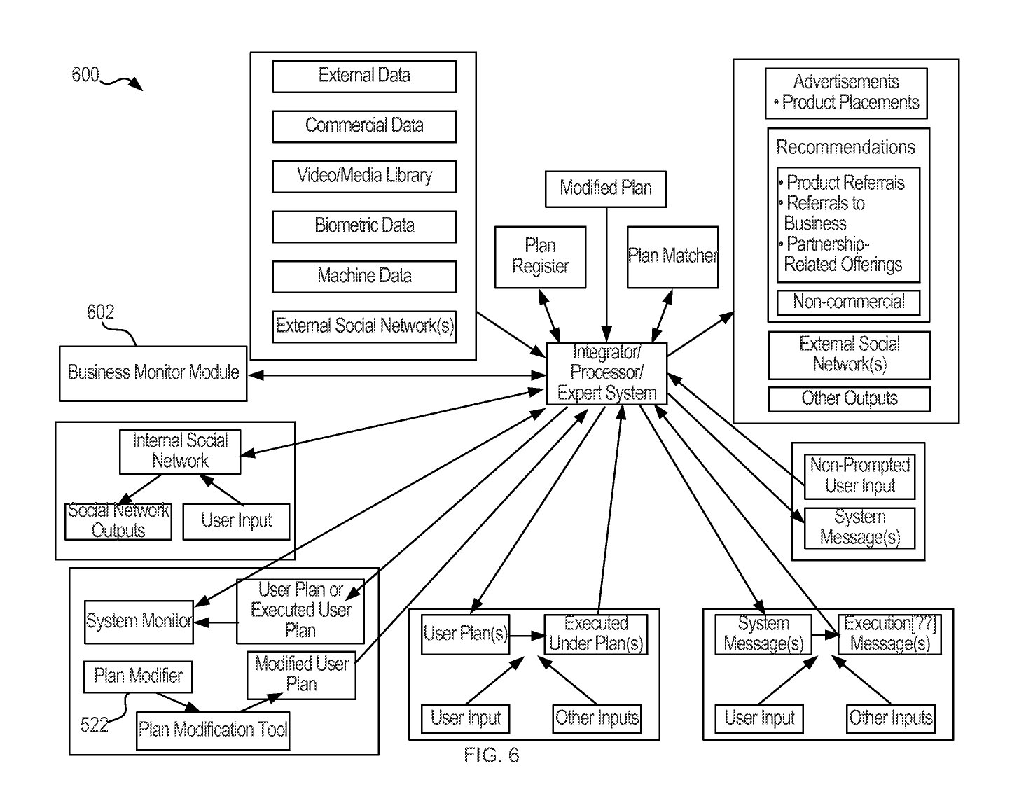

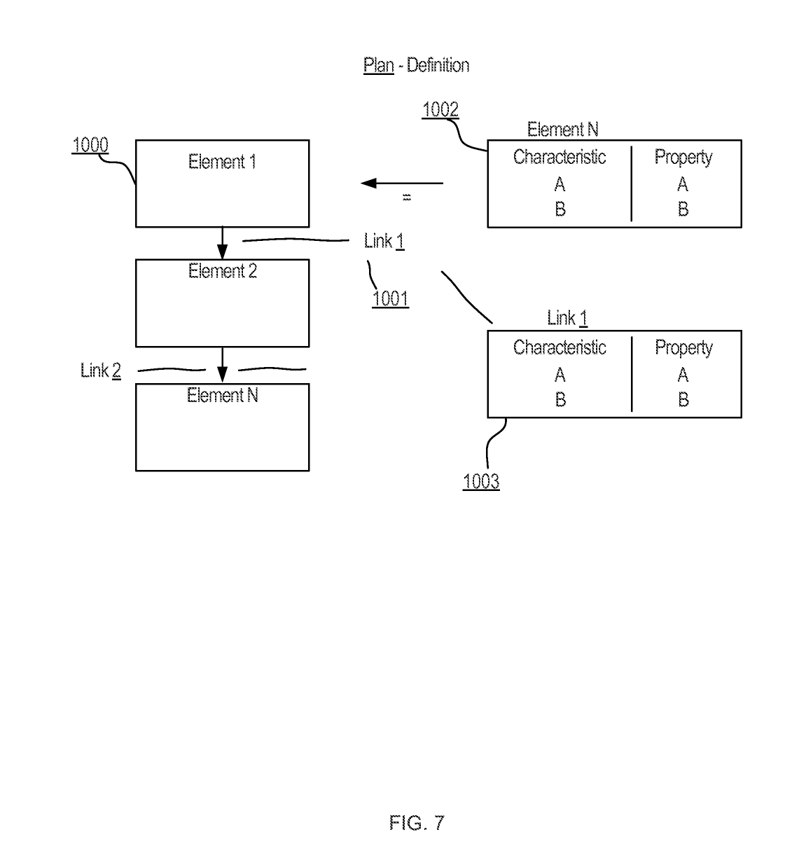

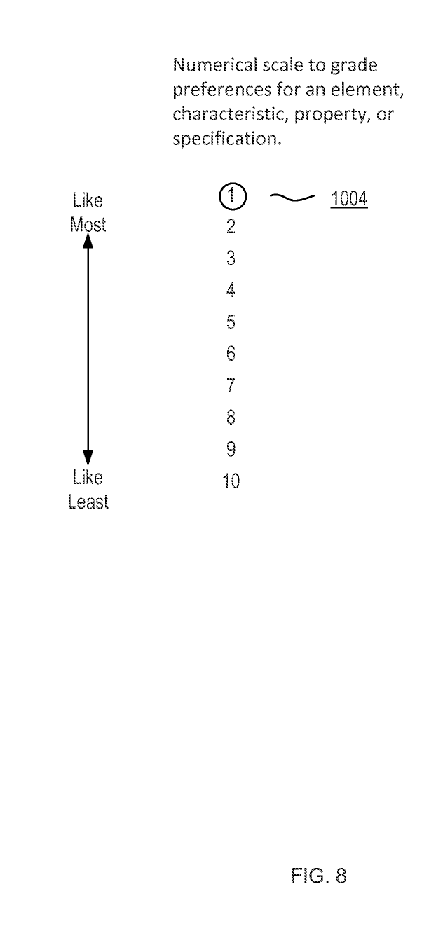

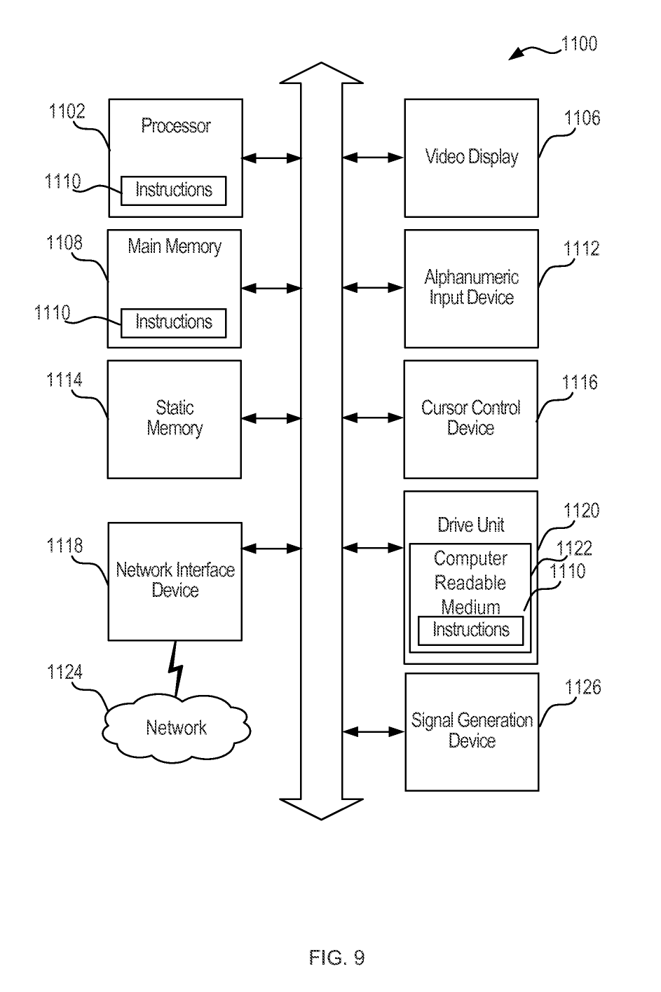

Preferences for elements, characteristics, of elements, properties of elements, specific items, or links (FIG. 6) may be specified (1004) by a user using a scale, or other choosing technique. For example a user may choose the highest preference 1, on a scale from one to ten.

FIG. 1. The matching logic (999), is defined as logic that matches user's preferences, by some type of logic, to produce the highest likelihood of agreement between users for a specific element, characteristic of an element, property of an element, specific item, or link from the creator plan (102).

User input (106, 106b) in the form of preferences flows to the matching logic (999) producing a computation of the highest likelihood for matching of each element of a selected plan (102). The plan integrator (104) integrates information from the creator plan (102), external data (114), matching logic (999), plan negotiator (112), user input (106, 106b). The plan integrator 104 then outputs a proposed customized group plan 108. The proposed customized group plan 108 is sent to each potential group plan participant 120, 120b for review. The plan may be emailed, or sent by any other means.

Users 120, 120b then review the proposed plan. They can accept the proposed plan. If so the plan is finalized (109).

Users 120, 120b can reject the proposed plan 110. The users can then be dropped as proposed participants (3002). Users 120, 120b, can then be contacted by the system 100, to notify the other users about the rejection. The potential users can contact the rejecting user(s) if wished to discuss the rejection.

Users 120,120b may also begin the process of negotiation through the plan negotiator 112. Through the plan negotiator 112 the user can:

1. Request a different plan 102. For example if the plan is a dinner and movie plan, the user may request that the plan 102 change to a swim and run plan

2. Request a change to one or more elements (1000) of the plan. For example, if the plan is a dinner and movie plan, the user may request that movie be replaced with bowling

3. Request a change to one or more of the selected characteristics (1002) of the plan. For example if the plan is a Dinner at Greek restaurant and movie plan. The user may request that the plan change to a Dinner at French restaurant and movie.

4. Request a change in a specific item in the plan. For example if the plan was Dinner at Aldo's Italian restaurant, the user may request the system suggest another Italian restaurant

5. Request a change to one or more of the links (1001) in the plan. For example if the plan was dinner followed by a 20 minute car ride to a movie, the user may request the link be within walking distance.

In certain embodiment when the system (100) receives a user's (120,120b) proposed changes, it may

1. Contact other potential group users (120, 120b) immediately to determine if the proposed changes are acceptable. For example the proposed changes may be a change in dinner from 6 pm to 7 pm. These changes may be acceptable to other plan participants 120, 120b.

2. Send the user 120, 120b other, less optimal, results from the matching program (999) to determine if these results are acceptable to the user

3. Run a new matching program (999). and then contact the user (120,120b) to determine if changes are satisfactory. If the changes are satisfactory the system (100) can send messages to other users 120, 120b with the new plan proposal.

If the proposed changes are accepted by the users the system 120, 120b send the users a Finished Group plan (109). In certain embodiments the plan creator (102) may have defined an acceptance level. For example a mountain hike plan may move out of negotiation status, and to an Accepted Finished plan when more than 5 participants agree to the plan. Another example, a group rally plan may move out of negotiation status, and into Accepted Finished status when more than 30 percent of invitees have agreed to the plan. In another embodiment the plan may move to out of negotiation status and to Accepted Finished status when a particular user, or users agrees to participate in the plan.

The integrator/processor/expert system 104 may be a standard system processor, which receives inputs from various other modules shown in FIG. 1, such as the creator plans 102 and user input, state, matching logic (999), and privacy settings (block 106). The inputs of the external data 114, plan negotiator (112), and plans of other users or user groups 116 are optional as shown by the dashed line in FIG. 1. The integrator/processor/expert system 104 then uses such inputs to create a unique or non-unique output in the form of the customized proposed group plan. As stated above, the integrator/processor/expert system 104 may use multiple creator plans to generate a single customized proposed group plan. This process may be referred to as integration of the multiple creator plans and involves creating a set of steps to achieve multiple goals.

The customized proposed group plan 108 represents an output of the system 100 that may contain one or more system-generated algorithms. These algorithms may be chronologically sequential or non-sequential, and they may contain aspects and elements of the multiple plans that the user is following. The non-sequential algorithm simply includes a list of tasks that need to be solved in any order to achieve a result. The non-sequential algorithm may contain sequential or non-sequential elements. The sequential algorithm may introduce an order in which the tasks are to be solved. The sequential algorithm may also include intermediate goals and may require that the user repeats certain tasks. Similarly, the sequential algorithm may contain sequential or non-sequential elements.

The customized proposed group plan, and customized final group plans 108 may be dynamically generated. That means that if a change is made to inputs used for generating the customized group plan, this change may also initiate, adjustment of the plan. Furthermore, subsequently acquired new data that was not available during the generation of the plan may be used to update the plan.

The customized proposed group plans 108 may be generated from multiple sources, with the creator plan being one of these sources. Multiple creator plans may be used. For example, if the user wishes to follow group travel plan and a group lunch plan concurrently, the integrator/processor/expert system 104 may output a customized group plan that contains elements appropriate. to both plans.

The generation and updating of the customized proposed group plans 108 may be based on the user's social network or his or her status. For example, the system 100 may rely on the social connections of the user to suggest a support system, organize events, and other functions. The status information may be used to determine the time availability, emotional status, and other factors pertinent to the generation and updating of the customized proposed group and final plans 108.

The customized group plans 108 may contain some or all of the elements of the creator plans 102. The customized group plans 108 may also contain the external data 114 and other data. For example, the creator plan 102 may set a goal for the users to hike 40 miles and then, if the goal is achieved, it may set up a celebration party. When the integrator/processor/expert system 104 determines that the goal is met, it outputs another customized group plan, or modifies the existing one to congratulate the users on their accomplishment while also recommending some specific venues and activities for the celebration. The integrator/processor/expert system 104 may then retrieve certain data from the users input or states, and the user's preferences. It may be determined that the user dislikes Middle-Eastern food but likes Italian food. In response, the integrator/processor/expert system 104 would refrain from suggesting a Lebanese restaurant for the party, and may instead conduct a search for Italian restaurants in the area.

Before describing the various methods and associated operations, a brief description of a computer. network is in order. Specifically, FIG. 2 illustrates an example network segment 200 for implementing various aspects of methods and systems for generating the customized group plans based on the one or more creator plans, in accordance with certain embodiments. Multiple computer systems 202a, 202b, 202c may be used by the plan users 120 or plan creators 122 for connecting to a plan generation server 206, as well as to other servers via the network 204. In certain embodiments, the one or more computer systems 202a, 202b, 202c may include a plan creation tool or setup wizard, as described elsewhere in this document. The one or more plan creation tools or setup wizards may be downloaded to the computer systems 202a, 202b, and 202c from the plan generation server 206. In other embodiments, they may be provided in the online web-based format and the computer systems 202a, 202b, 202c may be connected to a plan generation server 206 via the network 204 to use various functions of these applications. Various examples and features of the computer systems 202a, 202b, and 202c are described below with reference to FIG. 11.

The plan generation server 206 may be accessed by one of the computer systems 202a, 202b, 202c to generate the creator plans, or customized group plans. In certain embodiments, different servers are used for these two operations. The plan generation server 206 is also used to collect various data, such as use data, external data, and data pertaining to other plans. The various plans and data may be stored in one or more databases associated with the plan generation server 206. The plan generation server 206 may also include or be attached to the plan integrator/processor/expert system 104.

The plan generation server 206 may be also connected to the social network server 208 hosting the social network 208a. The social network server 208 may provide various degrees of access to data available from the social network 208a. This data may be provided by users 120 using the computer systems 202a, 202b, and 202c connected to the social network server 208. In certain embodiments, the social network 208 and plan integrator/processor/expert system 104 are parts of the same system and may be provided by a shared service.

The plan generation server 206 may also be connected to various external data servers 210 hosting various external data sources 210a. Various examples of the external data are provided above. The plan generation server 206 may retrieve the external data from the external data servers 210 to generate and update the customized group plans.

The network 204 may be also used for communication among various components of the plan generation system. The network 204 may take any suitable form, such as a wide area network (WAN), Internet, or one or more local area networks (LANs). The network 104 may include any suitable number and type of devices (e.g., routers and switches) for forwarding commands, content, or web object requests from each client to the online community application, as well as for sending responses to the clients.

The methods described herein may also be practiced in a wide variety of network environments (represented by network 204) including, for example, Transmission Control Protocol/Internet Protocol (TCP/IP)-based networks, telecommunications networks, wireless networks, and so forth. In addition, the computer program instructions may be stored in any type of computer-readable media. The program may be executed according to a variety of computing models, including a client/server model or a peer-to-peer model, on a stand-alone computing device, or in accordance with a distributed computing model, in which the various functionalities described herein may be implemented or employed at different locations.

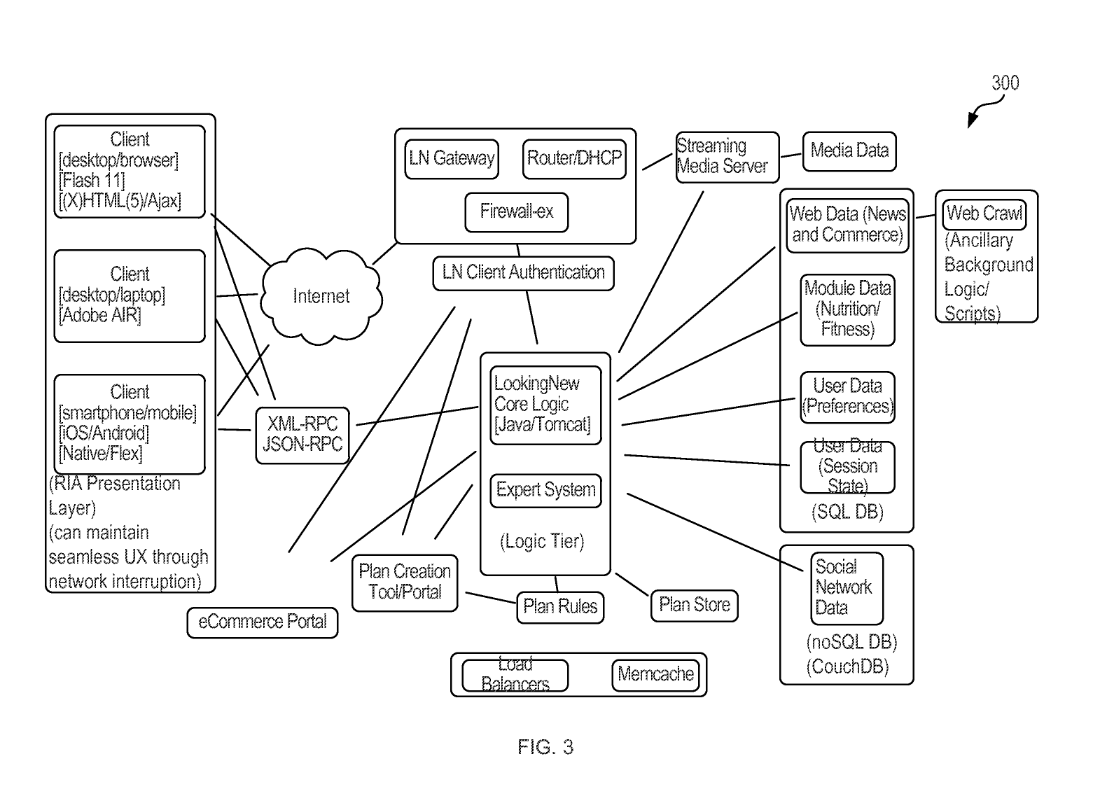

A brief example of system architecture is now presented to provide some context for the various operations described below. FIG. 3 illustrates the architecture 300 of a computer system for generating the customized group plan based on the one or more creator plans, in accordance with certain embodiments. The left-hand part of the diagram illustrates the various types of clients, such as browsers provided on desktops and smartphones, as well as the various software applications provided on the client. These clients are connected using the Internet and various protocols to various input/output modules of the plan integrator/processor/expert system 104, which includes the core logic, portals, rules, and other modules. The plan integrator/processor/expert system 104 may also include a plan store module, a matching module, and a plan negotiator module. The right-hand part of the diagram illustrates various types of data processed by the plan integrator/processor/expert system 104. Some examples include, but are not limited to, web data, module data, user data, and social network data.

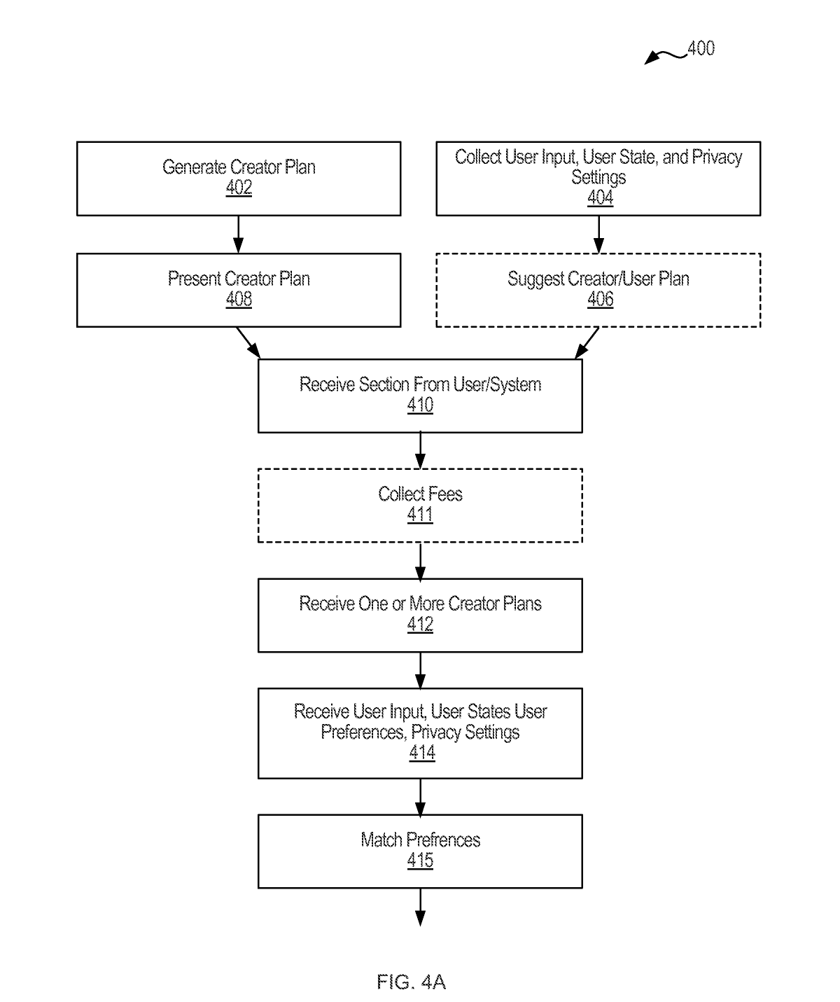

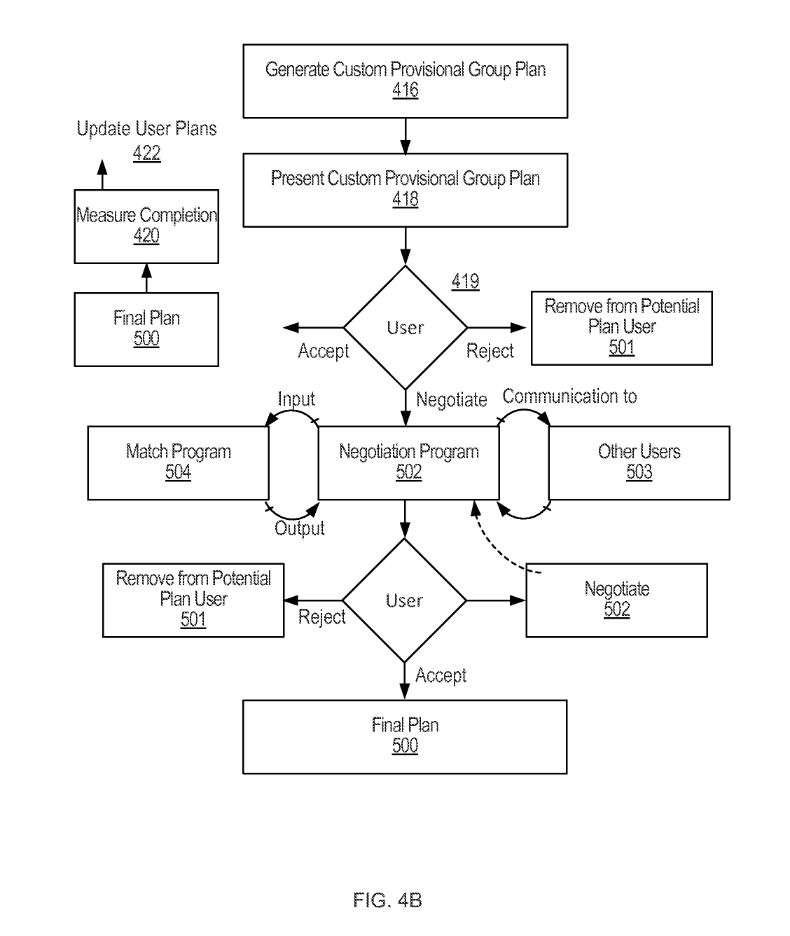

FIG. 4 is a process flowchart corresponding to computer-implemented method 400, in accordance with certain embodiments. The method 400 may involve generating the one or more creator plans at operation 402. At this operation, the one or more plan creators input various data into the system (for example, using the plan creation tool). As stated above, the plan creation tool may be available as an online web-based application or a downloadable application. The plan creator may access such an application and input various data. Examples of such data may include various instructions for users to follow, criteria for selecting and modifying the instructions based on data of different users and other types of data, description of the plan, disclaimers and notices, information about the plan creator, and other data. Some of this data may be suggested by the system. In certain embodiments, the plan creator may use one of the existing plans or templates as a starting point and then modify it as appropriate.

Part of the plan creation operation may be setting up usage fees for the plan, linking the plan to promotional materials, and using other ways of generating monetary compensation for the plan creator. In certain embodiments, the system sets the fee payable to the plan creator based on popularity, success, and other criteria associated with the plan.

A system may have one or more default user profiles (e.g., the most typical profile) for the testing of the creator plans. Furthermore, the system may have an engine capable of predicting whether the plan will be successful based, for example, on the feedback and history of the other plans that have been available from the system over a period of time.

In certain embodiments, depending on specific system settings, the one or more prediction results may be made available to the plan user, or one or more other users of the system, including the designated system user with appropriate clearance, the plan chooser, or the plan creator. The information regarding the probabilities of success of the particular group plan may be computed and presented dynamically by the system's engine logic, i.e. all changes to one or more types of data/inputs that the creator plan is based on may automatically be taken into account by the system, with the creator plan being modified accordingly. The information concerning the probabilities of success of the creator plan that is made available to the user, the designated system user with relevant clearance, plan chooser, or plan creator may include details as to which of the parameters of the creator plan are causative of the lowered or raised chances of the user's success. In this or other embodiments, the success of the prediction logic may be utilized to evaluate the probabilities of the success of the resulting plan when several creator plans are combined and integrated.

The one or more creator plans may be stored in the database of the system and may be available for presenting them to the users of the system. Access to the creator plans may be unrestricted or restricted. For example, the plan creators or the system may set a fee for the use of some of the selected plans. The plans may be also restricted based on various demographic aspects, such as age, gender, and geographic location. In certain embodiments, these restrictions may be used by the plan creators or by the system to determine the efficiency of the plan for a specific user group and to conduct various studies, similar to the clinical studies that differentiate patients.

In certain embodiments, multiple plans generated through the same or different systems may be available from the plan store. The plan store may be arranged and function similarly to the App Store or Android Market Place. Specifically, the creator plans may be categorized and ranked based on their type (e.g., celebration or romantic), availability free, fee-based), popularity number of uses), success (e.g., the number of users who have achieved their goals), ease of use, and other factors. In certain embodiments, the creator plans may be categorized by the likelihood of success for a particular user, which is determined based on the available information concerning the user, such as the user age, health-related characteristics, and so forth. The plan store may be used for leaving comments, taking part in rankings, or for receiving other feedback from the plan users 120. At some point in the process, the one or more plans may be presented to the user at operation 408. The plans may be browsed or searched for in a database of the system, or elsewhere (for example, in the plan store described above). Additionally, the plans may be searched for or selected in other locations in the application as well. Users may find the creator plans based on some key terms, plan creator identifications, and other indicators. In certain embodiments, the one or more creator plans or group plans may be suggested to the user by the system as shown by an optional operation 406. Such a suggestion may be based on various user data collected during the previous operations. For example, the user may first provide the user input, user state, and privacy settings to the system at operation 404. The user data may appear to be already available in the system due to the previous interactions of the user with the system. For example, some of the data may be accumulated during the user's acquisition and execution of previous plans. In certain embodiments, a new plan may be suggested to the user based on the completion of some previous plan, as further described below. In certain embodiments, the user input, user state, and privacy settings are collected using the set-up wizard, as explained above with reference to FIG. 1.

If any data on the user is stored in the system, the creator plans may be presented (at operation 408) or suggested (at operation 406) to the user in a partially or fully adopted format. In the fully adopted format, the creator plan may be the same as the users plan. The fully or partially adopted plan may be easier to review and understand, as well as appear more appealing to the user than the generic creator plan.

At some point, the system may receive a selection of the one or more plans from the user at operation 410. The selection may involve adding the one or more plans to the users shopping cart or account. During the selection process, the user may be presented with various legal disclaimers (e.g., instructing the user to consult his or her physician prior to using the plan), notifications, requests for additional information, and other types of data exchange with the system.

If any of the selected plans involve payment, the method 400 may proceed with collecting the fees from the user at optional operation 411. The user may be prompted to enter some payment information (e.g., credit card information, online payment service information). In certain embodiments, the user may be offered an option to reduce or, in more specific embodiments, eliminate the fees by subscribing to various promotions. For example, the user may choose a pub crawl plan that includes drinking and walking. The fee for the plan may be reduced if the user, agrees to purchase a beer mug from a selected source, or agrees to participate in some other promotional activities. In certain embodiments, the user may receive a promotional code for a free-of-charge or discounted purchase of the one or more creator plans or for a free-of-charge or a discounted subscription to the one or more creator plans. The offer may be made through a mailing or emailing campaigns, or through an existing membership channels. In certain embodiments. the right to a free-of-charge or discounted subscriptions may be granted in the form of promotional discount coupons.

The method 400 may involve retrieving the one or more creator plans at operation 412. This system may pick the plan. However, typically this operation is based on user selection of the one or more creator plans at operation 410. However, user data or external input may be used in addition to or even instead of the user selection for retrieving the one or more creator plans. For example, the creator plan presented to and selected by the user may have various levels of complexity. Certain data associated with this user may indicate that the user prefers simpler approaches to his or her plans. As a result of this preference reflected in the user data, a simpler version of the plan may be retrieved. In certain embodiments, some external data may impact this retrieval operation. For example, a travel plan initially selected by the user may include instructions for outdoor activities, such as biking. At the same time, the weather report (i.e., the external data) may indicate conditions (e.g., rain) that may prevent the user from following this plan precisely. In this situation, the weather report may be relied upon to modify the existing travel plan to refocus mostly on indoor activities. The user data used to retrieve the plan may be available in the system or collected from various external sources. For example, friends of the user may discuss the user's interest in high end dining on a social networking site. These conversations may be analyzed by the system to update the user data and retrieve a plan intended for an evening of high end dining. The user may be asked to select any such plan from the system. The plan may also be retrieved based on a recommendation, or even be a gift from another user of the system.

In order to create the customized provisional group plan based on the one or more creator plans retrieved at operation 412, the process first retrieves the user input, user state, privacy settings, at operation 414. The various examples of these parameters are presented and explained above. In certain embodiments, operation 414 also involves retrieving the external data, plans of other users or user groups, and other types of data, as was described above with reference to FIG. 1.

User preferences are then matched in operation 415. User input in the form of preferences flows to the matching logic producing a computation of the highest likelihood for matching of each element of a selected plan.

At operation 416, the method 400 may then proceed with generating the group plan based on integration of the one or more creator plans with the user input, user state, privacy settings, matched preferences, and results of negotiation associated with the users. In certain embodiments, the plan may be generated based on the external data or other user data in addition to other data mentioned above, Various examples of the external data and other user data are described above. In the same or other embodiments, multiple creator plans may be integrated with the user data to generate a single group plan. At operation 418, the generated provisional group plan is presented to the users.

The method 400 may proceed with receiving one or more responses from the user at operation 419. The users may elect to accept the proposed group plan. If this occurs the plan advances to final plan status 500. The user may reject the plan. If this occurs (501) the user may be removed from the group plan. The user may elect to negotiate with other users for alternative plans, plan elements, element characteristics, or specific plan items. If this occurs, the plan moves to the negotiation program 502

Through the plan negotiator 502 the user can:

1. Request a different plan 102. For example if the plan is a dinner and movie plan, the user may request that the plan 102 change to a swim and run plan

2. Request a change to one or more elements (1000) of the plan. For example, if the plan is a dinner and movie plan, the user may request that movie be replaced with bowling

3. Request a change to one or more of the selected characteristics (1002) of the plan. For example if the plan is a Dinner at Greek restaurant and movie plan. The user may request that the plan change to a Dinner at French restaurant and movie.

4. Request a change in a specific item in the plan. For example if the plan was Dinner at Aldo's Italian restaurant, the user may request the system suggest another Italian restaurant

5. Request a change to one or more of the links (1001) in the plan. For example if the plan was dinner followed by a 20 minute car ride to a movie, the user may request the link be within walking distance.

In certain embodiment when the system (100) receives a user's (120,120b) proposed changes, it may

1. Contact other potential group users (503) immediately to determine if the proposed changes are acceptable, For example the proposed changes may be a change in dinner from 6 pm to 7 pm. These changes may be acceptable to other plan participants 120, 120b.

2. (503) Send the user 120, 120b other, less optimal, results from the matching program (999) to determine if these results are acceptable to the user

3. Run a new matching program 504 and then contact the users 503 to determine if changes are satisfactory. If the changes are satisfactory, the system (100) can send messages to other users 503, 120b with the new plan proposal.

If the proposed changes are accepted by the users the system 120, 120b send the users a Finished Group plan 500. In certain embodiments the plan creator (102) may have defined an acceptance level. For example a mountain hike plan may move out of negotiation status, and to an Accepted Finished plan when more than 5 participants agree to the plan. Another example, a group rally plan may move out of negotiation status, and into Accepted Finished status when more than 30 percent of invitees have agreed to the plan. In another embodiment the plan may move to out of negotiation status and to Accepted Finished status when a particular user, or users agrees to participate in the plan.

If the plan is rejected 501, the potential group users may be removed, and an e-mail sent to other potential users.

The user may elect to negotiate with other users for alternative plans, plan elements, element characteristics, or specific plan items. If this occurs, the plan moves to the negotiation program 502

If the plan is finalized. The method 400 may proceed with receiving one or more responses from the user at operation 420. The responses may concern completion (or not) of the one or more instructions provided in the user plan. The system may prompt the user to submit such responses, for example, by sending various notifications (e.g., e-mails or text messages).

The method 400 may also involve updating the user plan at optional operation 422. The updates may be based on the one or more responses received from the user at operation 420, or based on changes to the user input, user state, user preferences, and privacy settings associated with the user. Once the updates are performed, the updated user plan is presented to the user.

FIG. 5 illustrates plan creation and selection-related processes employed by the system in generating customized group plans based on the one or more creator plans, in accordance with certain embodiments. The creator plans 102 may be created by the plan creators 122 using the plan creation tool 112 and uploaded to the plan store 506. The one or more creator plans 102 may then be filtered by the plan filterer 508 using the plan filter 512 or plan filtering tool 510, and stored in a filtered plan library store 518, from which the creator plans 102 may be retrieved by the plan chooser 514 using the plan selection tool 516. The one or more creator plans that have been filtered by 530 may be selected and retrieved from the filtered plan library/plan store 518 by the plan chooser 514 using the plan selection tool 516. The one or more creator plans that have been selected may be modified by the one or more plan modifiers 522 using the plan modifier device 526 or plan modification tool 524. The one or more creator plans that have been modified at 528 may subsequently be uploaded to the plan store 506.

FIG. 6 illustrates various aspects associated with processing of data by the system for generating customized group plans based on the one or more creator plans 102, in accordance with certain embodiments. The integrator/processor/expert system 104 receives various inputs from a number of the input sources. The data that is submitted into the system may include matching data, plan negotiator data, external data, commercial data, internal data, the inputs retrieved from the video/media library, biometric data, machine data, data from external social networks, and so forth. In certain embodiments, the input sources may comprise the internal social network (the input is user input processed by the internal social network), the system monitor (the input is a modified user plan or executed customized group plan), the plan user 120 (the input is a plan user-modified creator plan, or an executed customized group plan), and executed system messages that are used as plan user inputs. The business monitor module 602 that may or may not be part of the plan integrator/processor 104 may be used to track the usage of the system data by various commercial entities. Specifically, the business monitor module 602 may utilize data associated with various commercial entities to track commercial transactions, thereby enabling calculation and charging of a percentage of profits or a fee. For example, the business monitor module 602 may be used to process commercial data associated with the product placements, product referrals, referrals to businesses, and partnerships-related commercial opportunities. The system may be able to generate and export reports, exchange messages with external systems, including the external social networks, and so forth. The embodiment wherein the system for generating customized group plans based on the one or more creator plans includes the business monitor module 602 may be the best-mode-embodiment.

In certain embodiments, the related commercialization opportunities may include promotional coupons that avow plan users to receive the presented items at a discounted price, as well as various product placements, product referrals, referrals to businesses, such as for example, real-estate agents, restaurants, stores, car repair shop, and so forth. Products and services may be offered to plan users as a result of partnerships with manufacturers, service providers, or other vendors, which may also be featured in the creator plans, for example, as recommended by the vendors.

The application will dynamically choose the best or most appropriate commercial recommendations or referrals for the user based upon a number of different criteria, which may include, but not be limited to, user data, user preferences, external data such as the value of the product or the value of the sale to the company, computed characteristics, and so forth and will be computed by an algorithm within the application.

FIG. 11 is a diagrammatic representation of an example machine in the form of a computer system 1100, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STE), a Personal Digital Assistant (FDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor or multiple processors 1102 (e.g., a central processing unit (CPU), a graphics processing unit (GPU), or both), and a main memory 1108 and static memory 1114, which communicate with each other via a bus 1128. The computer system 1100 may further include a video display unit 1106 (e.g., a liquid crystal display (LCD)). The computer system 1100 may also include an alphanumeric input device 1112 (e.g., a keyboard), a cursor control device 1116 (e.g., a mouse), a voice recognition or biometric verification unit (not shown), a disk drive unit 1120, a signal generation device 1126 (e.g., a speaker) and a network interface device 1118. The computer system 1100 may further include a data encryption module (not shown) to encrypt data.

The disk drive unit 1120 includes a computer-readable medium 1122 on which is stored one or more sets of instructions and data structures (e.g., instructions 1110) embodying or utilizing any one or more of the methodologies or functions described herein. The instructions 1110 may also reside, completely or at least partially, within the main memory 1108 or within the processors 1102 during their execution by the computer system 1100. The main memory 1108 and the processors 1102 may also constitute machine-readable media.

The instructions 1110 may further be transmitted or received over a network 1124 via the network interface device 1118 utilizing any one of a number of well-known transfer protocols (e.g., Hyper Text Transfer Protocol (HTTP)).

While the computer-readable medium 1122 is shown in an example embodiment to be a single medium, the term “computer-readable medium” should be taken to include a single medium or multiple media (e.g., a centralized or distributed database or associated caches and servers) that store the one or more sets of instructions. The term “computer-readable medium” shah also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein may be implemented in an operating environment comprising software installed on a computer, in hardware, or in a combination of software and hardware.

Although the embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A computer-implemented method, comprising:
receiving, by a computer system, a plurality of matching plans configured to match a first preference of a first user with a second preference of a second user;
receiving, from the first user, first preference information including at least the first preference, the first preference information identifying first weighted preferences of the first user;
receiving, from the first user, a request to implement at least one of the plurality of matching plans;
identifying second preference information associated with the second user, the second preference information identifying second weighted preferences of the second user;
implementing, based at least in part on the first weighted preferences of the first user and the second weighted preferences of the second user, the at least one of the plurality of matching plans to generate, by the computer system, a compatible plan for the first user and the second user with a compatibility value above a threshold;
providing the compatible plan to at least one of the first user or the second user; and
determining whether the compatible plan is accepted by the first user or the second user.

2. The computer-implemented method of claim I, wherein implementing the at least one of the plurality of matching plans comprises:
comparing the first weighted preferences for a category with the second weighted preferences for the category; and
generating the compatible plan based at least in part on the comparison.

3. The computer-implemented method of claim 2, wherein the comparison includes further weighting the first weighted preferences or the second weighted preferences based at least in part on geo-location information associated with the first user or the second user, respectively.

4. The computer-implemented method of claim 2, wherein the category comprises an event, a type of event, a meeting, or a type of person.

5. The computer-implemented method of claim 1, wherein the request to implement the at least one of the plurality of matching plans includes a selection of a particular matching plan.

6. The computer-implemented method of claim 1, wherein the second preference information is identified by at least one of receiving the second preference information from the second user or identifying the second preference information from a database that manages user preferences.

7. The computer-implemented method of claim 6, wherein the second preference information is received from the second preference information at least in response to a request for the second preference information sent by the computer system.

8. The computer-implemented method of claim 7, wherein the request for the second preference information is sent using an email message, a text message, or a pop-up window of a user interface.

9. The computer-implemented method of claim 1, wherein providing the compatible plan comprises transmitting instructions, to at least one of the first user or the second user, for at least beginning the compatible plan.

10. The computer-implemented method of claim 1, further comprising generating a second compatible plan for the first user and the second user with a compatibility value above the threshold when the first user or the second user does not accept the compatible plan.

11. A system, comprising:
a memory configured to store computer-executable instructions; and
a processor configured to access the memory and execute the computer-executable instructions to at least:
identify first preference information identifying first preferences of a first user;
identify second preference information identifying second preferences of a second user;
generate, based at least in part on the first preferences of the first user and the second preferences of the second user, a compatible plan with a compatibility score for the first user and the second user; and
provide the compatible plan to at least one of the first user or the second user when the compatibility score is above a threshold.

12. The system of claim 11, wherein the processor is configured to further execute the computer-executable instructions to at least:
generate a plurality of additional compatible plans with respective compatibility scores; and
provide at least a subset of the plurality of additional compatible plans that have respective compatibility scores above the threshold.

13. The system of claim 12, wherein the processor is configured to further execute the computer-executable instructions to at least receive a selection, from the first user or the second user, of at least one of the provided compatible plan or the provided at least a subset of the plurality of additional compatible plans.

14. The system of claim 12, wherein the processor is configured to further execute the computer-executable instructions to at least determine an optimal plan out of a set including the provided compatible plan and the provided at least a subset of the plurality of additional compatible plans based at least in part on preference weights assigned by the first user or the second user, wherein the provided compatible plan is the optimal plan.

15. The system of claim 11, wherein at least one of the first preference information or the second preference information are received from the first user or the second user, respectively.

16. The system of claim 11, wherein at least one of the first preference information or the second preference information are retrieved from a database configured to be accessed by the processor.

17. A non-transitory computer-readable storage medium storing computer-executable instructions that, when executed by one or more processors, cause the one or more processors to collectively perform operations comprising:
identifying first preference information identifying first preferences of a first user;
identifying second preference information identifying second preferences of a second user;
receiving, from the first user, a request to implement a matching plan;
generating, based at least in part on the first preferences of the first user and the second preferences of the second user, a plurality of compatible plans for the first user and the second user with a compatibility value based at least in part on weights provided by the first user and the second user, respectively;
providing, to at least one of the first user or the second user, a subset of the plurality of the compatible plans with respective compatibility values above a threshold; and
receiving a selection, from at least one of the first user or the second user, of a particular compatible plan of the compatible plans.

18. The non-transitory computer-readable storage medium of claim 17, wherein the threshold is determined based at least in part, on at least one of the first preference information, the second preference information, a selection of the first user, a selection of the second user, a predetermined threshold identified as have a certain level of success, ratings, reviews, or external data.

19. The non-transitory computer-readable storage medium of claim 17, the operations further comprising:
receiving external data from a service provider; and
utilizing the external data to generate the plurality of compatible plans.

20. The non-transitory computer-readable storage medium of claim 19, wherein the external data includes at least one of a rating, a review, weather data, traffic data, calendar data, or geo-location information.

21. The non-transitory computer-readable storage medium of claim 17, the operations further comprising:
receiving external data from a service provider; and
utilizing the external data to identify the subset of the plurality of compatible plans to provide.

22. The non-transitory computer-readable storage medium of claim 15, the operations further comprising identifying at least a third user to include in the particular compatible plan that is selected based at least in part on third preference information associated with the third user.
